(19) United States
(12) Patent Application Publication
(10) Pub. No.: US 2013/0332611 A1
(43) Pub. Date: Dec. 12, 2013

(54) NETWORK COMPUTING OVER MULTIPLE RESOURCE CENTERS

(71) Applicants: Kirk A. Beaty, Goldens Bridge, NY (US); Yasuharu Katsuno, Kawasaki-shi (JP); Kiyokuni Kawachiya, Yokihama-sh (JP); Takayuki Kushida, Tokyo (JP); Vijay K. Naik, Pleasantville, NY (US); Yih-Shin Tan, Raleigh, NC (US)

(72) Inventors: Kirk A. Beaty, Goldens Bridge, NY (US); Yasuharu Katsuno, Kawasaki-shi (JP); Kiyokuni Kawachiya, Yokihama-sh (JP); Takayuki Kushida, Tokyo (JP); Vijay K. Naik, Pleasantville, NY (US); Yih-Shin Tan, Raleigh, NC (US)

(73) Assignee: INTERNATIONAL BUSINESS MACHINES CORPORATION, Armonk, NY (US)

(21) Appl. No.: 13/532,842

(22) Filed: Jun. 26, 2012

Related U.S. Application Data
(63) Continuation of application No. 13/490,836, filed on Jun. 7, 2012.

(51) Int. Cl. G06F 15/173

(52) U.S. Cl. 709/226

(57) ABSTRACT

A system for network computing includes a plurality of resource centers, each of the plurality of resource centers comprising one or more resource instances. The system also includes a resource manager that accesses a resource instance based on a user request, and a resource broker that facilitates communication between the resource manager and a respective resource center of the resource instance.

### CROSS-REFERENCE TO RELATED APPLICATIONS

This application is a continuation of U.S. patent application Ser. No. 13/490,836 filed on Jun. 7, 2012, the disclosure of which is incorporated by reference herein in its entirety.

### BACKGROUND

The present invention relates to network computing and, more specifically, to managing multiple resource instances over different resource centers within the network.

### SUMMARY

According to another embodiment, a computer program product for implementing network computing comprises a storage medium including computer-readable program code which, when executed by a processor, causes the processor to implement a method. The method includes receiving a request from a resource manager, the request including an attribute identifying a resource instance of a resource center among a plurality of resource centers within a hybrid resource center; detaching the attribute and forwarding the request to the resource center; receiving a response from the resource center; and attaching the attribute prior to forwarding the response to the resource manager, thereby facilitating access of the resource instance of the resource manager by the resource manager.

According to a further embodiment, a method for implementing network computing management includes receiving, by a resource broker, a request from a resource manager, the request including an attribute identifying a resource instance of a resource center among a plurality of resource centers within a hybrid resource center; detaching the attribute and forwarding the request to the resource center; receiving a response from the resource center; and attaching the attribute prior to forwarding the response to the resource manager, thereby facilitating access of the resource instance of the resource manager by the resource manager.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a cloud computing node according to an embodiment;

FIG. 2 depicts a cloud computing environment according to an embodiment;

FIG. 3 depicts abstraction model layers according to an embodiment;

FIG. 4 depicts a network computing system according to an embodiment;

FIG. 5 illustrates image registration by a resource manager;

FIG. 6 illustrates resource instance provisioning by a resource manager;

FIG. 7 illustrates resource instance operation by a resource manager;

FIG. 8 illustrates multi-resource instance provisioning by a resource manager;

FIG. 9 illustrates image registration by a resource management system according to an embodiment;

FIG. 10 illustrates resource instance provisioning by a resource management system according to an embodiment;

FIG. 11 illustrates resource instance operation by a resource management system according to an embodiment;

FIG. 12 illustrates multi-resource instance provisioning by a resource management system according to an embodiment; and

FIG. 13 depicts the processes involved in performing network computing according to embodiments.

### DETAILED DESCRIPTION

Exemplary embodiments relate to the management of multiple resource instances over different resource centers in a network. A resource instance, as described herein, refers to a virtual computer with a specified memory, processing cores and units defined for a particular platform, such as a 32- or 64-bit platform, or other resource, such as a platform itself or a software application, accessible over the network. In one exemplary embodiment, the network environment operates via a cloud infrastructure.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed (e.g., any client-server model)

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Exemplary characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

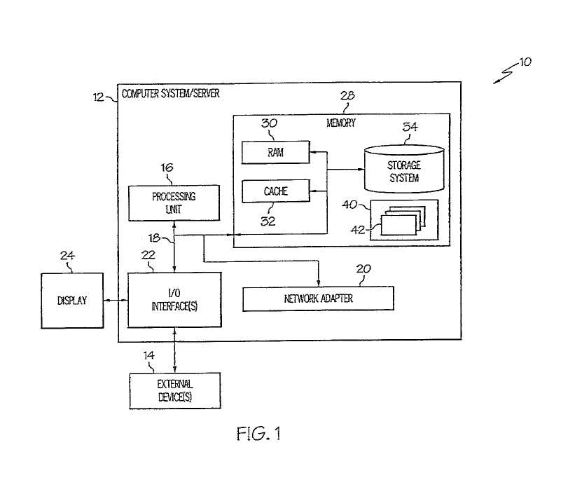

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such resource instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

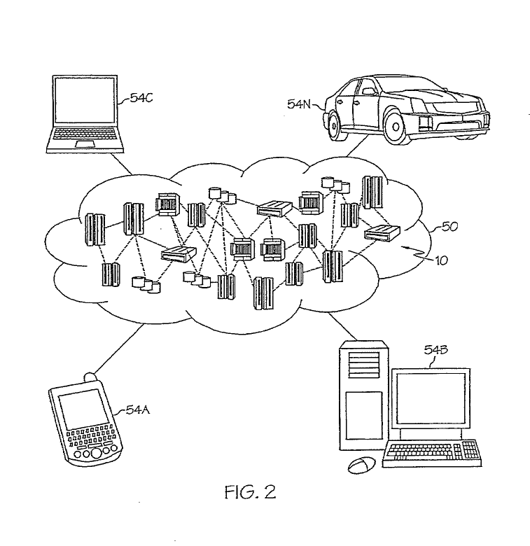

Referring now to FIG. 2, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

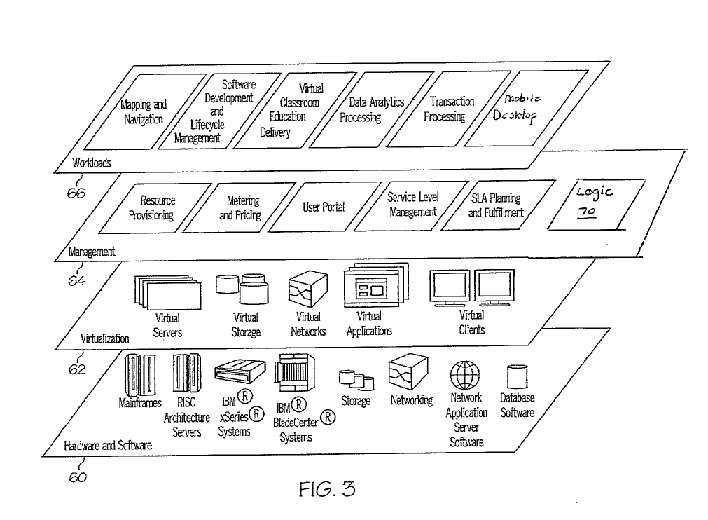

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2C®, database software. (IBM, zSeries, pSeries, xSeries, BladeCenter, WebSphere, and DB2 are trademarks of International Business Machines Corporation registered in many jurisdictions worldwide)

Virtualization layer 62 provides an abstraction layer from which the following examples of virtual entities may be provided: virtual servers; virtual storage; virtual networks, including virtual private networks; virtual applications and operating systems; and virtual clients.

In one embodiment, one or both of the hardware and software layer 60 and the virtualization layer 62 may include edge components, such as a web server front end and image cache, as well as an image library store, e.g., in a high-performance RAID storage area network (SAN).

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security (not shown) provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. In one exemplary embodiment, logic 70 in the management layer 64 implements the exemplary network computing management processes described herein; however, it will be understood that the logic 70 may be implemented in any layer.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a mobile desktop for mobile devices (e.g., 54A, 54C, and 54N, as well as mobile nodes 10 in cloud computing environment 50) accessing the cloud computing services.

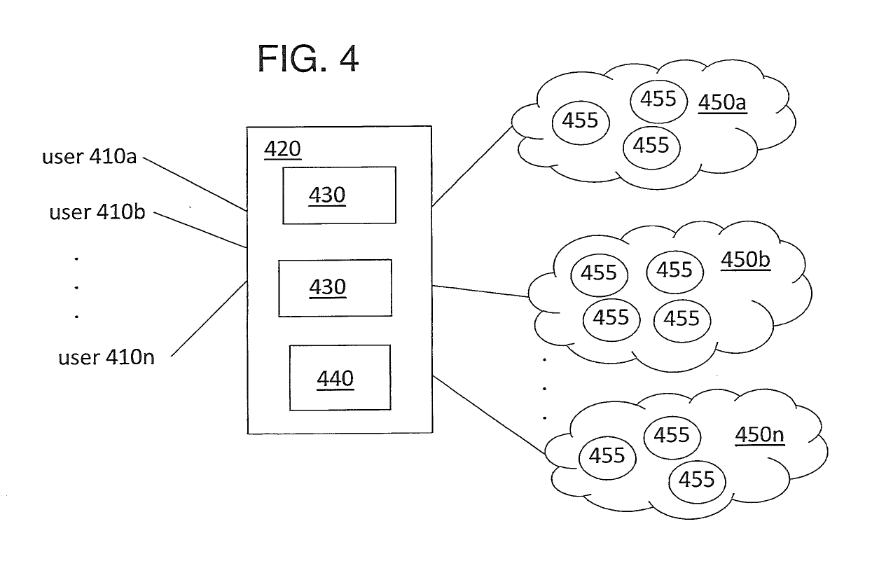

FIG. 4 depicts a network computing system 400 according to embodiments of the present invention. The network computing system 400 includes users 410a-410n. In one or more embodiments, these users 410 may be, for example, cloud consumers as discussed above. The users 410 access one or more resource instances 455 in resource centers 450. In embodiments, a resource instance 455 in a resource center 450 may be, for example, an apportionment of some or all of a computer system/server 12 in a cloud computing node 10 within a cloud computing environment 50 of interconnected computing nodes 10. For example, a resource instance 455 may be a virtual machine or another type of resource. The resource management system 420 enables the users 410 to create and configure one or more resource instances 455 (use one or more resources available within the resource centers).

The resource management system 420 includes a resource manager 430 and a resource broker 440. Although two resource managers 430 are shown by the embodiment of FIG. 4, one, two, or any number of resource managers 430 may share a resource broker 440. Further, while the resource managers 430 are shown with the resource broker 440 to form the resource management system 420, each of the resource managers 430 may be part of a respective user 410 device. In addition, each resource manager 430 may have a corresponding resource broker 440 in each respective user 410 device. In an embodiment involving a cloud computing environment 50, the resource manager 430 is a cloud manager that allows a cloud consumer to create one or more resource instances 455 (access one or more computer system/server 12) in a given resource center 450 (within a cloud computing node 10). As detailed below, the resource broker 440 extends the functionality of the resource manager 430 and enables the user 410 to create and configure resource instances 455 that may be in different resource centers 450. The resource management system 420 may be viewed as a server or collection of servers including functionality of one or more resource managers 430 and resource brokers 440.

Embodiments of the present invention are detailed below with specific reference to cloud computing. However, these exemplary embodiments are not intended to be limiting. It should be understood that the principles and features discussed herein apply in alternate embodiments to network infrastructures and architectures other than the cloud infrastructure.

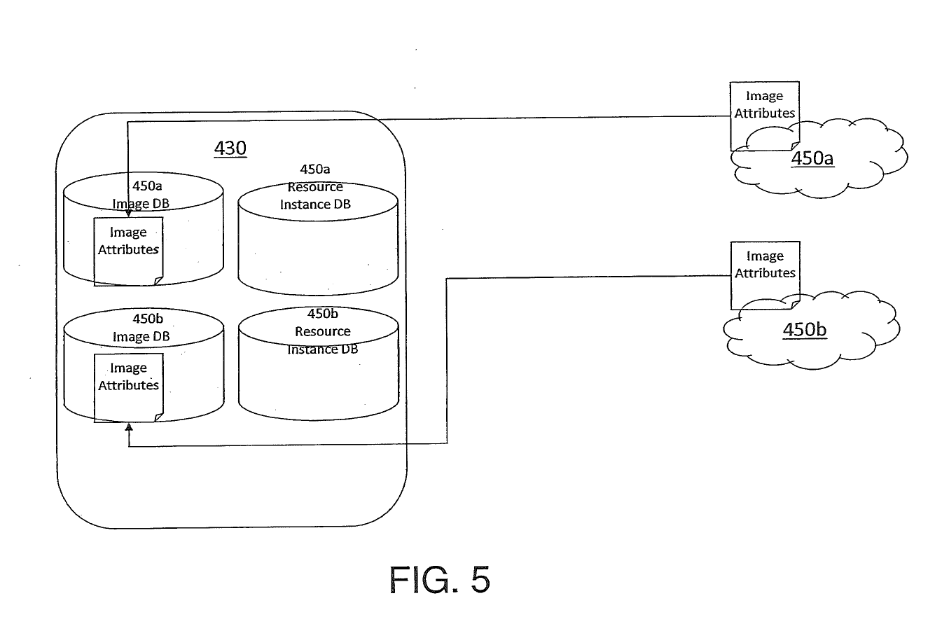

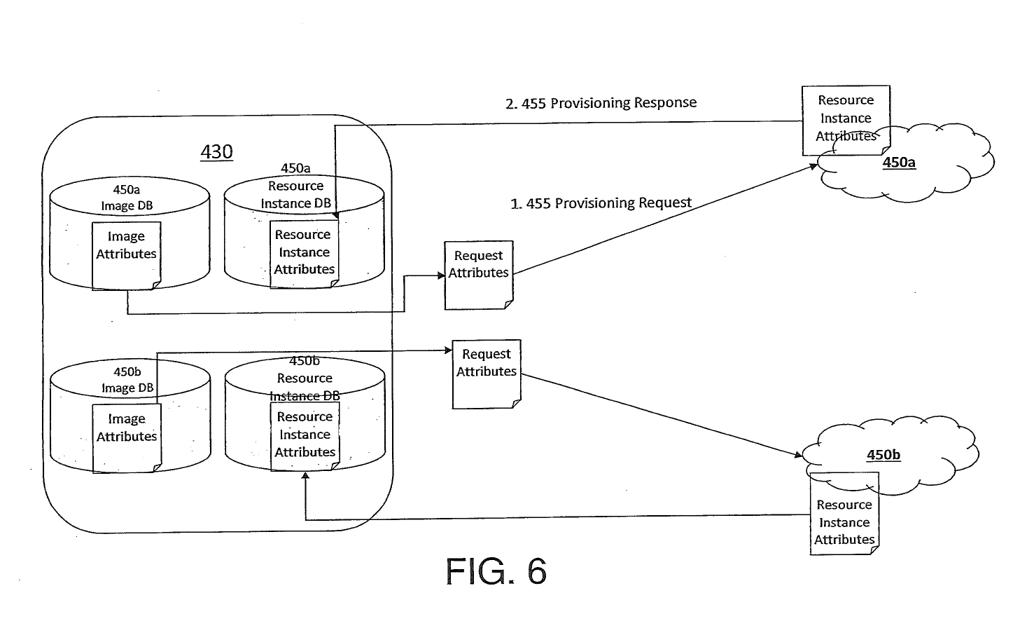

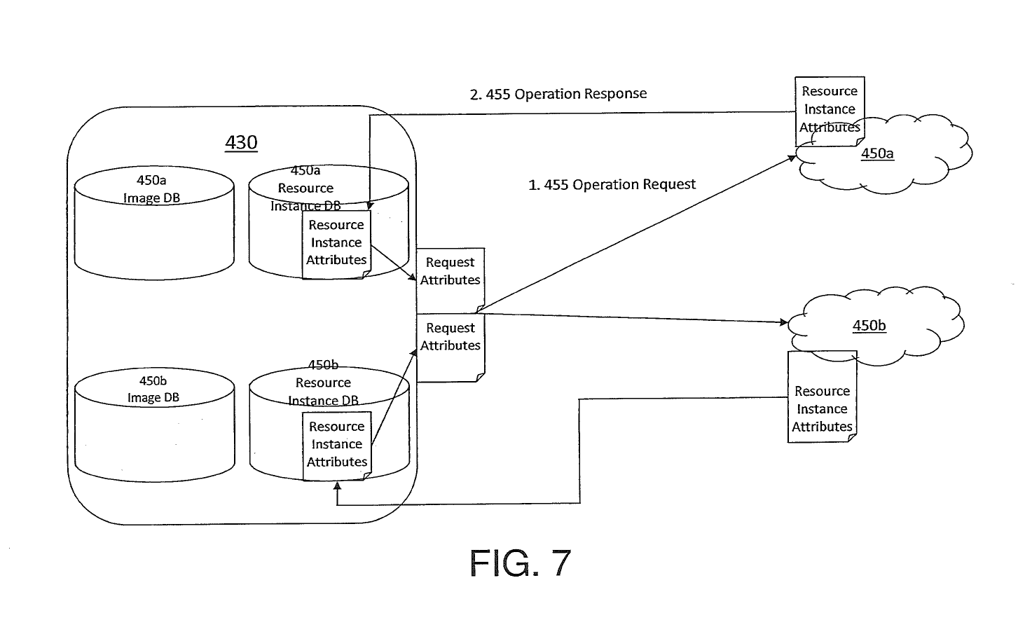

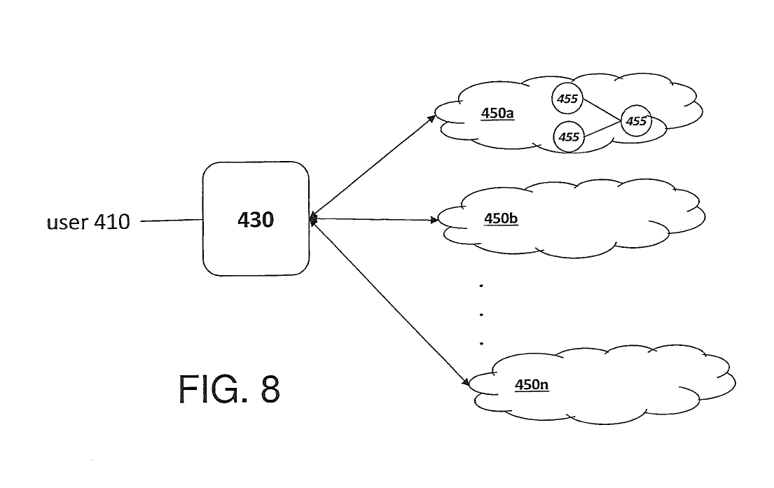

FIG. 5 illustrates image registration by a resource manager 430. As shown, registration is specific to each resource center 450 such that the resource manager 430 maintains a separate image database with image attributes acquired from each resource center 450 during the registration process. FIG. 6 illustrates resource instance 455 provisioning by a resource manager 430. Once the registration process shown at FIG. 5 is completed, the resource manager 430 requests and receives resource instance 455 attributes from the resource center 450 associated with the requested resource instance 455. Thus, as shown, the resource manager 430 requests resource instance 455 attributes from each resource center 450. FIG. 7 illustrates that resource instance 455 operation by the resource manager 430 requires a separate request and response to be addressed to the respective resource center 450 associated with each resource instance 455. FIG. 8 illustrates multiple-resource instance 455 provisioning by the resource manager 430. As shown, when the resource manager 430 provisions multiple resource instances 455, those multiple resource instances 455 are associated with the same resource center 450.

That is, when the resource manager 430 deploys a pattern of resource instances 455, the resource manager 430 cannot generate that pattern over multiple resource centers 450 due primarily to the fact that the resource manager 430 maintains separate databases for registration and provisioning with respect to the different resource centers 450 as shown by FIGS. 5 and 6. As the following figures illustrate, the addition of a resource broker 440 according to embodiments enables multiple resource instances 455 to be provisioned in different resource centers 450 without changes in the functionality of the resource manager 430.

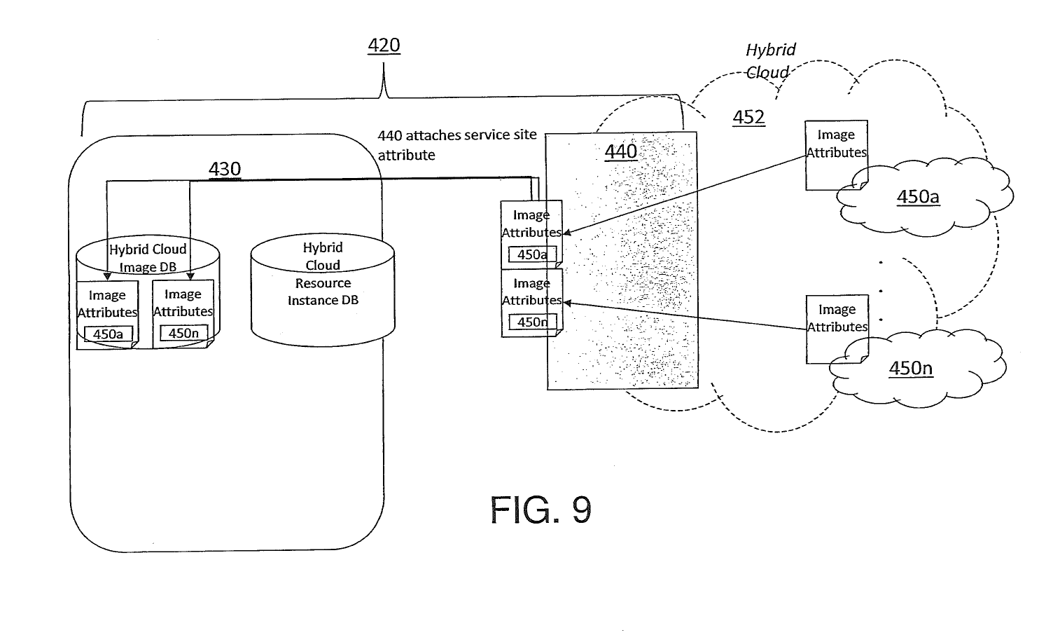

FIG. 9 illustrates image registration by a resource management system 420 that includes a resource manager 430 and a resource broker 440 according to an embodiment. As shown, the resource centers 450a-450n (e.g., cloud computing nodes 10, FIG. 1) are regarded as a hybrid resource center 452 (hybrid cloud) by the resource manager 430. The resource manager 430 includes an attribute identifying a particular resource center 450 within the hybrid resource center 452 (within the hybrid cloud) in each request. The resource broker 440 essentially functions as a go-between or translator. The resource broker 440 detaches the attribute included by the resource manager 430 when it communicates with a particular resource center 450 (identified by the attribute) and attaches the attribute in communications back to the resource manager 430 from the hybrid resource center 452. With regard to image attributes, however, the resource manager 430 sends a request for image registration to the resource broker 440 without any attribute. The request is essentially for all images that match a specific condition in the request. The image attributes received based on the request are modified to include target resource center 450 (cloud) attribute information which is included by the resource manager 430 in subsequent communications with the resource broker 440.

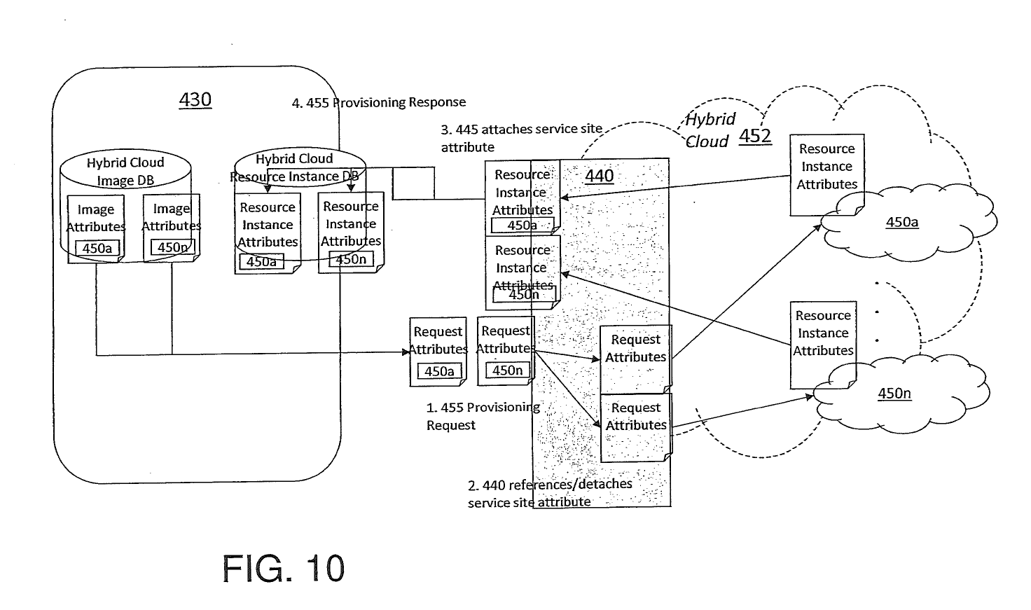

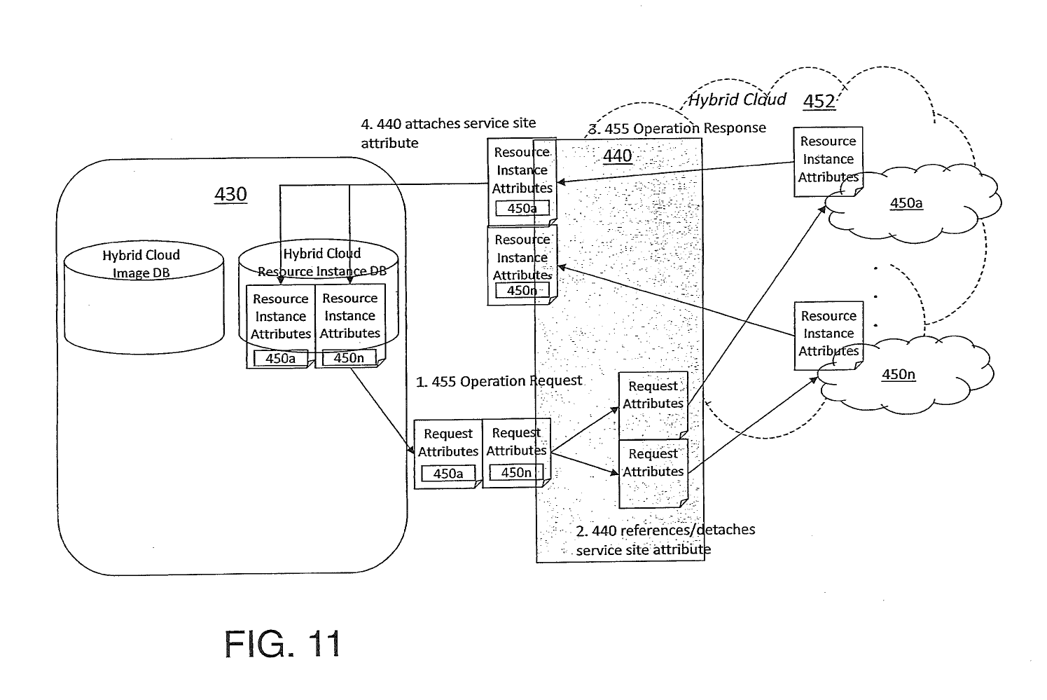

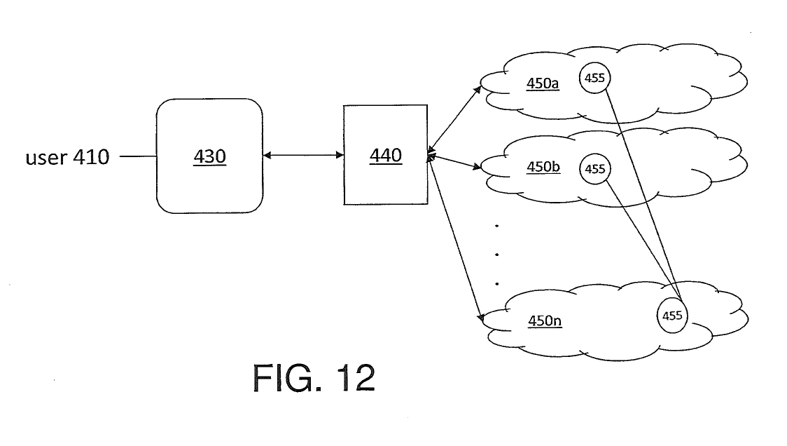

FIG. 10 illustrates resource instance 455 provisioning by a resource management system 420 according to an embodiment. As noted with reference to FIG. 9, the resource manager 430 views all the resource centers 450a-450n as a single hybrid resource center 452. The resource broker 440 detaches and attaches attributes in communications from and to the resource manager 430 in order to facilitate access from a user 410 through the resource manager 430 to a particular resource instance 455 of a given resource manager 450 identified by the attribute attached by the resource manager 430. FIG. 11 illustrates that the resource instance 455 operation, like the resource instance provisioning, for resource instances 455 across multiple resource centers 450a-450n is viewed as operation of resource instances 455 within a single hybrid resource center 452 by the resource manager 430. Again, the resource broker 440 detaches and attaches attributes in communications from and to the resource manager 430 to and from resource instances 455 of the resource centers 450. FIG. 12 illustrates the result of including the resource broker 440 in the functionality of the resource management system 420. As shown, the addition of a resource broker 440 according to embodiments of the present invention enables a user to provision multiple resource instances 455 from different resource centers 450 without any changes in the functionality of the resource manager 430.

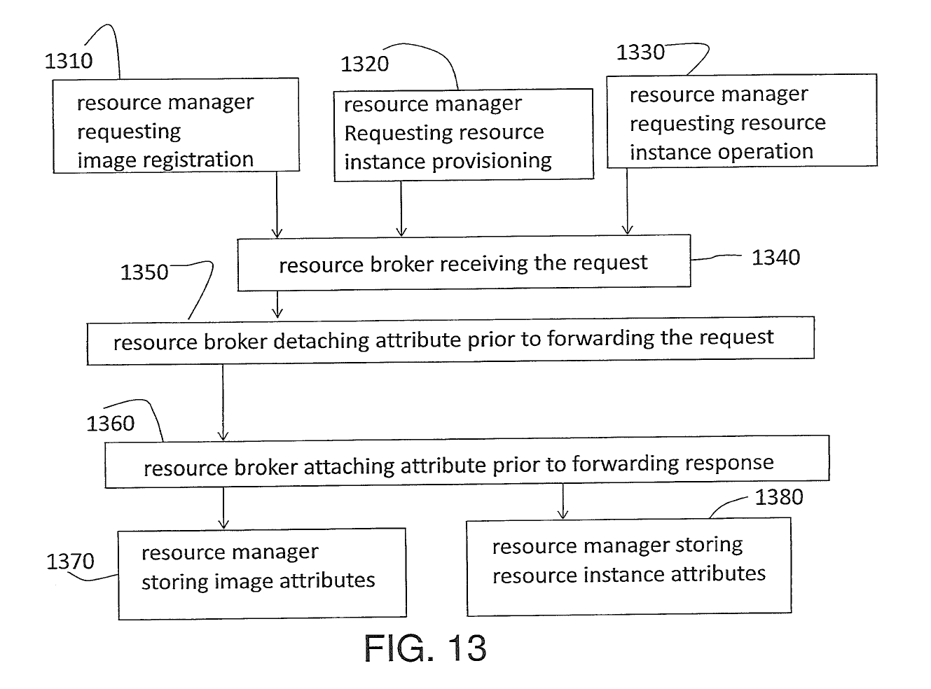

FIG. 13 depicts the processes involved in performing network computing according to embodiments. While the processes are shown with a particular flow, it should be understood that alternate embodiments contemplate variations in the order and additions or other modifications in the processes. The processes at 1310, 1320, and 1330 relate a user accessing a resource instance 455 via a resource manager 430. Accessing a resource instance 455 includes the resource manager 430 sending a request to register images (at 1310), provision a resource instance 455 (at 1320), and perform an operation with a resource instance 455 (at 1330). The provision and operation requests (at 1320, 1330) include an attribute identifying the resource center 450 of the resource instance 455 of interest. The processes include the resource broker 440 receiving the request from the resource manager 430 at 1340. At 1350, detaching the attribute (in the case of provisioning and operating requests) prior to forwarding the request to the resource center 450 is done by the resource broker 440. At 1360, attaching the attribute to the response from the resource center 450 prior to forwarding to the resource manager 430 is also done by the resource broker 440. As discussed above, because the resource manager 430 views all the resource centers 450 as part of a hybrid resource center 452, based on the responses to the requests, at 1370 and 1380, respectively, the resource manager 430 performs storing image attributes for all the different resource centers 450 resulting from registration requests in a common database and storing resource instance attributes for all the different resource centers 450 resulting from provisioning requests in another common database.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

As noted above, the flow diagram depicted herein is just one example. There may be many variations to this diagram or the steps (or processes) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A non-transitory computer program product for implementing network computing management, the computer program product comprising a storage medium including computer-readable program code which, when executed by a processor, causes the processor to implement a method, the method comprising:
receiving a request from a resource manager, the request including an attribute identifying a resource instance of a resource center among a plurality of resource centers within a hybrid resource center;
detaching the attribute and forwarding the request to the resource center;
receiving a response from the resource center; and
attaching the attribute prior to forwarding the response to the resource manager, thereby facilitating access of the resource instance of the resource manager by the resource manager.

2. The non-transitory computer program product according to claim 1, further comprising registering the image, wherein registering images of different ones of the plurality of resource centers includes forwarding image attributes from the different ones of the plurality of resource centers, after attaching respective attributes, to the resource manager for storage in a common first database.

3. The non-transitory computer program product according to claim 1, further comprising provisioning the resource instance, wherein provisioning resource instances of different ones of the plurality of resource centers includes forwarding resource instance attributes from the different ones of the plurality of resource centers, after attaching respective attributes, to the resource manager for storage in a common second database.

4. The non-transitory computer program product according to claim 1, wherein the accessing includes sending requests for one or more operations to the resource instance.

5. A method for implementing network computing management, the method comprising:
receiving, by a resource broker, a request from a resource manager, the request including an attribute identifying a resource instance of a resource center among a plurality of resource centers within a hybrid resource center;
detaching the attribute and forwarding the request to the resource center;
receiving a response from the resource center; and
attaching the attribute prior to forwarding the response to the resource manager, thereby facilitating access of the resource instance of the resource manager by the resource manager.

6. The method according to claim 5, further comprising registering the resource instance, wherein registering resource instances of different ones of the plurality of resource centers includes the resource broker forwarding image attributes from the different ones of the plurality of resource centers, after attaching respective attributes, to the resource manager for storage in a common first database.

7. The method according to claim 5, further comprising provisioning the resource instance, wherein provisioning resource instances of different ones of the plurality of resource centers includes the resource broker forwarding resource instance attributes from the different ones of the plurality of resource centers, after attaching respective attributes, to the resource manager for storage in a common second database.

8. The method according to claim 5, wherein the accessing includes sending requests for one or more operations to the resource instance.
